(19) United States
(12) Patent Application Publication
(10) Pub. No.: US 2021/0281510 A1
(43) Pub. Date: Sep. 9, 2021

(54) HIGH-RESOLUTION CONTRACT-BASED WIRELESS NETWORK VIRTUALIZATION

(71) Applicant: Deixis, PBC, Seattle, WA (US)

(72) Inventors: Allen L. BROWN, JR., Lake Oswego, OR (US); Patrick J. D. SANTOS, Kirkland, WA (US)

(21) Appl. No.: 17/192,856

(22) Filed: Mar. 4, 2021

Related U.S. Application Data
(60) Provisional application No. 62/985,739, filed on Mar. 5, 2020.

(51) Int. Cl. H04L 12/715; H04L 12/721; H04L 12/24; H04L 12/66

(52) U.S. Cl. CPC H04L 45/64; H04L 12/66; H04L 41/12; H04L 45/38

(57) ABSTRACT

Techniques to apply consensus-based network routing using distributed ledgers are disclosed. Communications networks are virtualized thereby enabling software defined networking (SDN). A SDN scheduler or allocator makes use of routing techniques where the state of the network is persisted in a form of storage that all nodes are in consensus is accurate. Since the SDN scheduler or allocator may rely on knowledge of the network state, it need not rely on optimistic routing techniques and thereby realize routing efficiencies. In some cases, the state of the network is comprised of MPLS histories where each MPLS history as a trace of network activity that is implemented as a well-marked and well-decorated tree. Persistence may be via a distributed ledger, software transactional memory or a relational database management system. Finally, operad techniques from abstract algebra may be applied to enable routing at an arbitrary level of fidelity ranging from the level of individual intermediate hops, to groups of hops within a Border Gateway Protocol (BGP) Autonomous System (AS) domain, to BGP AS domains themselves.

### CROSS-REFERENCE TO RELATED PATENT APPLICATIONS

This application claims priority to U.S. Provisional Patent Application No. 62/985,739 filed on Mar. 5, 2020, and entitled “High-Resolution Contract Based Wireless Network Virtualization,” which is hereby incorporated by reference in its entirety.

### BACKGROUND

Wireless communications are communications that generally utilize radio frequency (RF) rather than physical lines as a transmission medium for endpoints. As with wired communications, wireless communications are between endpoints, defined as terminals which are the consumers of communications, such as smartphones and computers. Intermediate communications between endpoints may be wired; for the definition of wireless communications, only a single terminal in a session needs to be wireless since the inclusion of a single wireless terminal gives rise to the issues around wireless communications.

Wireless communications have several advantages, most notably that of ubiquity. In turn, ubiquity provides several emergent properties. Since endpoints are not tied to a physical location, endpoints may be mobile. In fact, wireless networks need not be static; they may be “ad hoc,” e.g., endpoints may connect and communicate “just-in-time.”

Adding to the dynamic nature of wireless communications, the ad hoc endpoints may also include ad hoc underlying communications fabric. Because the endpoints are mobile, they may roam between different networks. Roaming may be between networks using regulated frequencies such as for cellular networks or maybe between licensed and unlicensed networks such as between cellular networks and Wi-Fi networks. To manage spectrum utilization, Mobile Network Operators (MNOs) (in a network slicing implementation) may switch endpoints to different overlaid networks depending on the profile of network use. For example, a user streaming a 4K movie might be allocated a high-bandwidth network, where a user sending a text might be allocated a low-bandwidth network. As different networks may have different owners, even with communications standards, the different owners may not trust each other for auditing, billing, and government/regulatory/compliance (GRC) issues. GRC issues further complicate matters since regulated radio frequencies are not just subject to spectrum allocation regulations, but also compliance with public use laws. Two notable such public use laws are around Enhanced-911 (E-911) regulations for emergency calls, and around the Communications Assistance for Law Enforcement Act (CALEA) which regulates wiretapping where law enforcement has a valid search and seizure warrant.

Presently, MNOs and other wireless network operators rely on software-defined network (SDN) technology to virtualize their networks. Network slicing (dynamic/elastic allocation of network bandwidth), mobile/multi-access edge computing (MEC) which can be conceptualized as “Just-In-Time data” and Multi-Protocol Label Switching (MPLS) give rise to determining routing dynamically. As a result, the virtualization models used with present SDN are based nearly exclusively on routing issues, with models conceptually biased toward physical networks (e.g., models illustrating routing from one virtual intermediate node to another virtual intermediate node).

However, network allocation optimization and management are also based on the underlying use case at a particular time and there is a need to build High-Resolution virtualization models that take into account use cases. In turn, there is a need for those virtualization models to provide the basis of novel software-defined network infrastructure.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a diagram of an example cellular network environment that includes an exemplary SDN to implement a contract-based High-Resolution network abstraction.

FIG. 2 is a diagram of an example scenario that illustrates a block diagram of a network environment for the SDN that implements the contract-based High-Resolution network abstractions.

FIG. 3 is an example topology diagram of an Advanced Research Projects Agency Network (ARPANET) that includes a first wide-area packet-switching network service with distributed control.

FIGS. 4-6 illustrate an example implementation of formalization of a contract and symmetric asset exchanges among parties to the contract.

FIGS. 7-16 illustrate an example implementation of using undirected wiring diagrams to model configurations of a digital communications network and using directed wiring diagrams to model the forwarding tables controlling packet forwarding in digital communication networks.

FIGS. 17-21 illustrate an example implementation of using mathematical algebras on directed and undirected wiring diagrams to model network properties.

### DETAILED DESCRIPTION

### Overview

### Temporality-Aware Network Abstraction Models

Computer science, and by inclusion networking as a subject of study, is replete with abstraction models. While a computer may physically be comprised of a processor with low-level op-code instructions (machine language), a programmer may write a program in a high-level programming language. What makes machine language low-level is the fact that the constituent op-codes are conceptualized in terms of the processor, such as registers, interrupts, and physical memory. In contrast, a high-level programming language is conceptualized in terms of the problem to be automated. Such terms may include objects (for object-oriented paradigms), logical assertions (for logical programming paradigms), lambda expressions (for functional programming), and so on. In other words, an abstraction model allows an end-user such as a programmer or a network designer, or a network administrator to think in terms other than the underlying physical details of the computers.

Turning to computerized communications networks, abstractions of the communications networks are biased towards routing issues or are non-specific with respect to use cases. Specifically, current abstractions of communications networks are not temporality-aware (i.e., aware of routing requirements for specific points of time). In the former case, the Abstract Communication Model of Distributed Systems (see Glasser, Gurevich, and Veanes) models network architecture without regard to temporality and the dynamic nature of communications. In the latter case, the famous Open Systems Interconnection Model (OSI Model) has layers with increasing levels of abstraction ranging from the physical layer to the presentation and applications layers. However, again, the increasingly abstract layers are concerned with routing to software applications such that packets and/or messages are properly understood, rather than considering temporality and the dynamic nature of communications.

Even software tools suffer from the same deficiency of not being temporality-aware. Cisco Systems, Inc. (Cisco), has an introductory network simulator known as Packet Tracer™. While network scenarios may be run on Packet Tracer™, the emphasis is on connectivity and configuration of network nodes, usually Cisco switches and routers.

### Contract-Based High-Resolution Network Abstractions

A consequence of abstraction models not being temporality-aware is that it is either prohibitively difficult or impossible to model Service Level Agreements (SLAs), i.e., contracts between network providers and customers to transfer/transmit data with speed and time requirements. Note that a communications connection is not only of the terminal to the network but of a series of intermediate network nodes. An intermediate hop is the transmission of data during a single particular communication in a session between two adjacent network nodes in the series of nodes. However, SLAs are generally written for large time windows comprising multiple sessions rather than for a single session, let alone for an intermediate hop. This is because of the present lack of abstraction models that may underlie an SDN implementation or networking tools in general.

Another consequence is that peering relationships, that is to say, promises to transfer data from one network to another without an intervening third-party network, are difficult to model and therefore optimize on a per session basis. For example, peering is typically implemented with Border Gateway Protocol (BGP), which supports state transitions indicating availability and capacity of so-called “Autonomous Systems” (AS's), i.e., the brokers of peering data transfers, to transfer data. However, ensuring that an AS is available with sufficient capacity at peak data transfer times is not modeled in present network abstractions used for SDN.

This state of affairs is not for a lack of instrumentation or data. For example, Call Detail Records (CDRs) typically contain not only endpoint and intermediate routing information, but also the time that a call session started and the duration. In other words, CDRs are temporality-aware.

This suggests that an abstraction that models not only volume of data and the quality of service (as expressed in terms of speed and bandwidth), but also the time-window of availability would support modeling SLA guarantees. Contracts are such an abstraction. Specifically, contracts can cover an arbitrary promise, including temporality. An example of a standard, non-technical legal contract is an employment contract that specifies the time, manner, and place that the employee is to comply with.

Turning back to networks, a network abstraction model where a primary artifact is a contract specifying at least data volume, quality of service guarantees, and availability time windows, would be sufficiently expressive to support SLAs and other similar assertions and promises. For the remainder of this disclosure, the term “contract” will refer to the above network abstraction model artifact. When referring to legal artifacts which are subject to legal concepts of offer, acceptance, and consideration, rather than computer science or networking concepts, this disclosure will specifically use the term “legal contract.”

Further enhancing a contract includes the notion of High-Resolution. Considering a present SLA, an MNO may promise to a customer a particular volume of data and quality of service for the entire term of the legal contract comprising the SLA. However, in practice, the customer has different capacity needs at specific times and locations on a per session basis. A child contract with session scope would be subject to a global SLA but may either add or may specialize through inheritance the session-specific promises. Taking this concept to another level of detail hops between intermediate nodes for transmissions in a session can be understood as promises of delivery of a volume of data, with a specified quality of service, at a specific time. Accordingly, contracts via addition or specialization through inheritance may include intermediate hop promises. Note that in an alternative implementation, contracts for intermediate hops and/or sessions may be separate contracts containing back-references SLA contract or any other contract. In this way, a contract may be considered fine-grained or High-Resolution, that is the contract supports a per-session or potentially a per intermediate-hop degree of specificity.

### Emergent Properties of Contract-Based High-Resolution Network Abstractions

Thus far, only SLAs have been discussed. However, a contract-based High-Resolution network abstraction provides sufficient fidelity to model for a whole host of other network issues. Accordingly, an SDN with such an abstraction may then manage and optimize around those network issues.

One network issue is around the notion of auditability. Auditability is concomitant with network SLAs—an MNO should be able to prove to the customer that an SLA was honored. Furthermore, for roaming between cellular networks, and with spectrum sharing (see for example Authorized Shared Access (ASA) and Licensed Shared Access (LSA) telecommunications standards) scenarios, an MNO should be able to prove that promises to other parties were honored as well. Note that the parties to such agreements do not necessarily trust each other. As described later in this disclosure, Distributed Ledger Technology (DLT) may be used in some embodiments to broker trust. Use of DLT for SLA scenarios are described in further detail in section “Towards Confirmation of Service Levels Provided via Verifiable, Auditable Contracts on Distributed Ledgers” below based on the unpublished paper of the same name by Allen L. Brown and Patrick J. Santos, applicants for the present disclosure, whereof this paper is included later below in this disclosure.

While auditability relates to promises made before a session and confirmation that promises were kept after a session, contract-based High-Resolution networking models also address network issues of the session itself.

Another issue is around network security. Presently, MNOs as well as their customers are subject to a barrage of network cyberattacks. However, with High-Resolution contracts, i.e., contracts at a per intermediate hop basis, routes may be dynamically reconfigured faster than the time for a malicious actor can intercept or tap calls. Accordingly, a malicious actor is reduced to attacking either the scheduler or endpoints, but the direct attacks on the network communications paths themselves may be rendered less economical.

### SDN Built on Contract-Based High-Resolution Network Abstraction Models

As previously stated, the implementation of a contract-based High-Resolution network abstraction model is typically manifested in a Software-Defined Networking (SDN) managing software. Thus far, we have proposed a contract as a computing artifact. Note that as an abstraction, contract-based High-Resolution models may be built not only on DLT but also on traditional relational database management systems (RDBMSs) and on transaction logs, potentially persisted on software transactional memory (STM). Different persistent regimes, based on specific data structures, are described in section “Label Switching Histories” based on the unpublished paper of the same name by Allen L. Brown and Patrick J. Santos, applicants for the present disclosure, whereof this paper is included later below in this disclosure.

In particular, the constituent operations supported by a contract will depend on objects being operated on. In particular, an object may have a “type” that constrains or defines what operations are valid for an object of that type. One example structure is a data structure known as a directed tree. A directed tree is guaranteed to be fully ordered and well decorated and via novel techniques disclosed herein be used to model dynamic routing histories such as with Multi-Protocol Label Switching (MPLS). These techniques are described in further detail in section “Label Switching Histories,” below.

However, as an abstraction, the contract-based High-Resolution network abstraction model enables an SDN to have a virtualized communications network at a per intermediate hop basis that is use case (request-aware) and temporality-aware.

First of all, because the contract model is an abstraction unless performing low-level maintenance, the network administrator works in terms of temporality-aware contracts rather than the physical network. Because physical location and geography of physical network nodes impact speed of transmission (hence the rise of edge computing), SDNs still need to consider physicality. However, temporality-aware contracts indirectly capture physicality with a time to delivery field. This is akin to people in traffic-congested cities using units of time rather than distance to describe transit (saying “the airport is an hour away in traffic”, rather than saying “the airport is ten miles away”).

Also, because the contract model is capable of modeling at a per intermediate hop basis, scheduling of intermediate hops may be conceived in terms of offers and bids between potential network nodes (virtual or physical). In this way, service agreements can be on a per session basis, and confidence in scheduling may be increased because before a per session service agreement is entered, the SDN can monitor all the potential available intermediate hops.

Accordingly, with this degree of fidelity, and by tying network service level performance requirements to use case and temporality, the SDN supporting this model then has several emergent abilities. The SDN can now schedule per session, per intermediate hop requirements on a per request (per contract) basis. As described below, physicality constraints are translated into temporal constraints in a contract, and schedulers are used to honor the contracts.

Connectivity, configuration, and control of nodes, physical or virtual is also enabled by the SDN. As will be described below, a contract-based High-Resolution network abstraction affords the importation of categorical theory/abstract algebra mathematical techniques called operads. Operads enable the abstraction of operational semantics of nodes as algebras (usually manifested by computer science types, e.g., an object of type X is constrained to perform only methods for type X). Furthermore, operads through a technique called “wiring diagrams” enable the rigorous expansion or flattening (called “evaluation”) of networks to a desired level of abstraction. This enables a network administrator to zoom in and out of the appropriate level of abstraction when reviewing a network, but with a mathematically rigorous level of specificity. In fact, undirected wiring diagrams correspond to connectivity/configuration scenarios, and directed wiring diagrams, where direction corresponds to causality relationship correspond to network control scenarios. Operads are described in further detail in section “Digital Communications Network Configurations as Operads of Wiring Diagrams” based on the unpublished paper of the same name by Allen L. Brown and Patrick J. Santos, applicants for the present disclosure, whereof this paper is included later below in this disclosure.

### Example SDN Utilizing a Contract-Based High-Resolution Network Abstraction

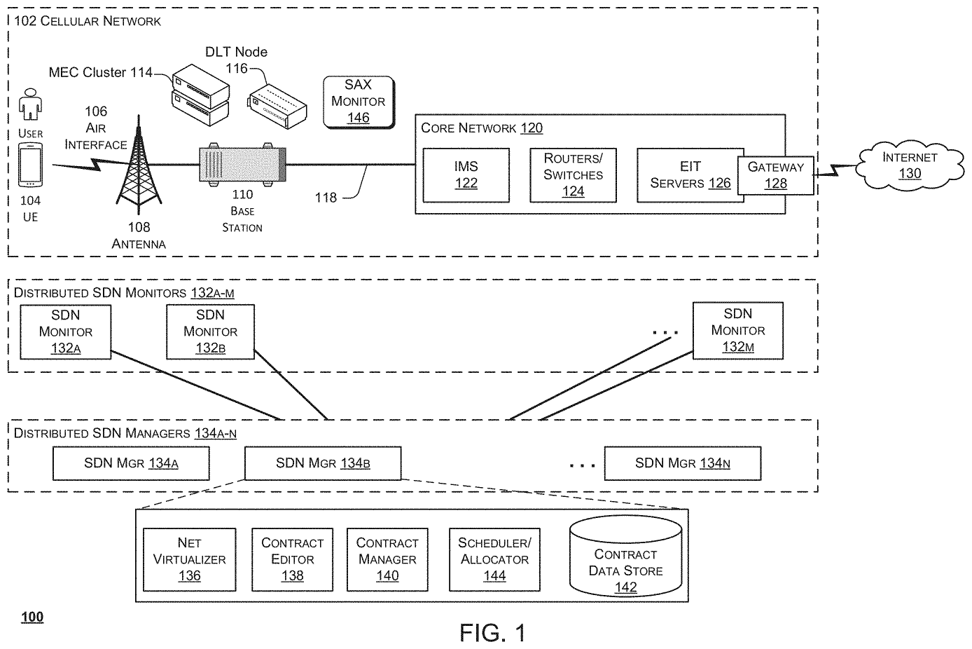

FIG. 1 is an example cellular network environment 100 including an exemplary SDN that implements a contract-based High-Resolution network abstraction. In one example, a cellular network 102 that is the subject of the SDN may include a mobile terminal 104, known in industry parlance as “user equipment.” Example mobile terminals 104 may include a laptop, a personal digital assistant (PDA), a satellite radio, a global positioning system (GPS), IoT devices with a tracking mechanism, a multimedia device, a video device, a camera, and/or other similar functioning devices.

Mobile terminals 104 may connect wirelessly over the Air Interface 106, which implements the encoding standards for cellular protocols such as LTE and HSPA. The other terminal of the Air Interface 106 is a cellular antenna 108.

A base station 110 is connected to multiple antennas 108 over fiber optic cables or other physical lines. The base station 110 may include a base station scheduler 112 that is responsible for allocating digitized bandwidth to various channels for various respective mobile terminals 104. In one example, these channels may be dynamically allocated and configured at the packet level.

Base stations 110 may receive data from intermediate cells such as picocells and femtocells (not shown). In some cases, base stations 110 may mediate devices using unlicensed spectrum such as Wi-Fi access points and home routers (not shown).

In the present SDN embodiment, the base stations 110 also includes a mobile/multi-access edge compute (MEC) cluster 114 that can provide edge computer/edge cache services for the mobile equipment 104. The SDN embodiment may also include a DLT node 116 to track transactions for auditing purposes. In some embodiments, the DLT node 116 may include DLT verifiers acting on behalf of interested parties.

Backhaul 118 may include the physical lines from the base station 110 to a Core Network 120. The backhaul 118 are typically comprised of fiber optic lines. Collectively, the antennas 108, base station 110, and the backhaul 118 are known as the Access Network since it acts as a collection “funnel” of communications requests from various geographically disparate mobile equipment 104 to access the Core Network 120.

The Core Network 120 is where the bulk of the routing is performed. The Core Network 120 may route packets in the cellular network 102, which in turn may eventually find the location of the terminal mobile equipment 104 and forward accordingly. A Core Network 120 may include an IP Multimedia System (IMS) infrastructure 122, which is responsible for validating incoming communications requests various routers, switches 124 comprising the nodes in intermediate hops, and enterprise information technology (EIT) servers 126. EIT servers 126 may provide the platforms for service functionality. Examples include voice mail and short message service (SMS) functions.

A special EIT server 126 is a gateway 128 that provides access to the Internet 130. Internet services are generally not resident in the Core Network 120 and therefore are mediated by the gateway 128.

In an embodiment, the cellular network 102 may be virtualized in two ways. First, many of the functions from the access network (base station 110 and associated infrastructure) to the Core Network 120 may be implemented on containers on virtual machines. Thus, strictly speaking, we have a “virtual network.”

The second way is to allocate resources via software-defined networking (SDN). While not strictly required for SDN, containers create not only elastic cloud capability (allocate and deallocate virtual machines as needed for present capacity) but also are quickly responsive and easy to instrument with software. Accordingly, where a cellular network has been substantively hosted on virtual machine containers, network resources can be sliced and allocated in best fit situations dynamically.

To implement the SDN, we parallel analogous infrastructure to the physical cellular network 102 with SDN monitors 132a-m and SDN managers 134a-n. The layer of SDN monitors 132a-m may receive telemetry from the physical cellular network 102. The SDN managers 134a-m may then send commands to the physical cellular network 102 to dynamically allocate resources such as network channels.

Turning to SDN monitors 132a-m, each of the components from the mobile equipment 104 through gateway 128 may have a respective SDN monitor, each of which provides telemetry and access controls to its respective component. In some cases, a component may expose telemetry and access control via a native API. In other cases, a separate SDN monitor may be configured and deployed.

Further, the layer of SDN Manager 134a-n may interpret the telemetry in view of contracts. For example, the SDN Manager 134a-n itself is comprised of several software components. The SDN Manager 134a-n may be hosted in the Core Network 120 itself, or maybe hosted remotely on a server in the cloud, or maybe hosted on a base station 110. The SDN Manager 134a-n may expose its functionality through a web-based interface and therefore can be accessed remotely.

Each of the SDN Manager 134a-n may be comprised of various software utilities including a network virtualizer 136. The network virtualizer 136 receives telemetry from each of the SDN monitors 132a-m and builds a virtual model of the present capacity of the network, down to the intermediate hop level, of the entire network. Accordingly, for each hop or intermediate hop, network capacity associated with at least a time window of availability is visible. Also, quality of service and data payload type may be specified as well.

In an embodiment, the capacity represented in the network virtualizer 136 may be allocated to contracts. Accordingly, each of the SDN manager 134a-n further includes a software contract editor 138 to create contracts, a software contract manager 140 to track contracts and deploy contracts, and a contract data store 142 to persist contracts, metadata of contracts, and contract performance.

Note that the network virtualizer 136 is free to choose any abstraction for modeling the network. Some non-trivial models include homology and co-homology models of network nodes. Beyond homological models, the network virtualizer 136 may not only enable formal mathematical models and abstractions of the network and other related states, the network virtualizer 136 can include infrastructure to perform formal mathematical proofs that can add mathematical confidence to both static aspects (e.g. correctness of a smart contract or of a particular network configuration), and dynamic aspects (e.g. showing reachability of available autonomous systems). Mathematical proof infrastructure is readily available via Coq, Isabelle, and other automated proving software. For example, in the case of border gateway protocol (BGP), the University of Washington has a software tool known as “Bagpipe” that performs formal mathematical verification of BGP configurations.

Once a contract is deployed via the software contract manager 140, an SDN scheduler/allocator 144 accesses the network virtualizer 136 to identify candidate paths that are likely to be made use of for a session, and based on temporal data from the intermediate hops, makes quality of service representation to one or more mobile equipment terminals 104. Upon scheduling, the network channel is allocated by the scheduler/allocator 144.

Note that many parties and nodes are communicating with each other during routing. In some cases, tracking is performed by the DLT node. However, exchanges may be guaranteed with a transaction monitor. In the present embodiment, a DLT enabled form of transactions may be enabled via Symmetric Asset Exchange (SAX) Monitor 146. In SAX, the DLT node 116 may perform the intermediate checks prior to an exchange between two nodes. In this way, the selected standard transactional requirements (atomicity, consistency, isolation, and durability) may be enforced. SAX is described in further detail in the applicant's prior Provisional Patent Application, “Anonymous Distributed Consensus Regarding the Verification of Protocols” Application No. 62/712,792 and in further detail in the section “Towards Confirmation of Service Levels Provided via Verifiable, Auditable Contracts on Distributed Ledgers,” below.

### Consensus and Contracts as a Service (C2aaS)

In one embodiment, the net effect of placing DLT node on the network edge (e.g., at base station 110) in concert with SDN is to create a consensus. The key effect of the consensus is that because state is trusted, all stakeholders in the accuracy of the state may proceed in reliance on the state reported by the DLT node.

The state reported by the DLT node is the state of the network and the state of the data transported by the network as provided by the SDN monitors 132a-m. Stakeholders and third parties may also opt to share additional state such as payment fulfillment, other fulfillment, and external state. Commands to change the state of the network may be implemented via the SDN managers 134a-n, which themselves are distributed.

Since the DLT node may create consensus to determine performance of parties (and of the network), it creates the basis to create contracts. Accordingly, this infrastructure creates the basis for “Consensus and Contracts as a Service” (C2aaS). In C2aaS, we place the DLT nodes 116 on each cellular network node, such as the base station 110. The DLT node 116 is interfaced with a DLT enabled transaction monitor—SAX monitor 146. The DLT node 116 may be also interfaced with the base station 110 itself, the associated SDN monitors 132a-m and associated SDN managers 134a-n.

The SDN managers 134a-n may deploy a smart contract to the DLT nodes 116 (not just at the base station but all DLT nodes 116 that are in consensus under the DLT protocol). The network virtualizer 136 of the SDN manager 134 has the ability to select an arbitrary level of abstraction via the use of operadic techniques. Accordingly, a smart contract may be defined at an arbitrary level of abstraction.

In one example, the smart contract may be deployed via a monetization infrastructure abstraction such as via a bidding exchange. Alternatively, the smart contract may be simply deployed by fiat by a system administrator. A typical system administrator would be an MNO administrator. Common scenarios to implement via smart contract are privileging E-911 transmissions, controlling when to enable CALEA provisions, and other governance, regulatory and compliance requirements.

Upon deployment, the SDN monitors 134a-m may report the network state. The DLT node 116 or a third party oracle may determine if and when to offer to post the network state to the DLT node 116. The SAX monitor 146 may then collect the posted network state offers and determines which pairs or sets of post network state offers are exchange conditions for each other. Upon determining the satisfaction of the exchange conditions, the SAX monitor 146 posts the network state to the DLT node 116. In this way, the consensus from the DLT node 116 provides consensus on the network which in turn enables symmetric exchange conditions. Because the network is virtualized, the network state need not be of a physical router or switch or base station, but rather of a network resource allocation as created by the SDN manager 134.

Furthermore, with the use of operadic techniques, smart contracts may be deployed at any level of abstraction. Moreover, above this infrastructure of DLT, SAX, operads, and SDN, online exchanges (e.g., exchanges for offers and acceptance of contracts which in turn form the basis of smart contracts to be deployed) may be put in place.

Examples of consensus based network routing algorithms are set forth in the paper, “Consensus Routing: The Internet as a Distributed System” by John, Katz-Bassett, Krishnamurthy, Anderson and Venkataramani and elsewhere in the literature. In the section above titled, “C2aaS” an arbitrary consensus based algorithm, such as Paxos, is shown to be implemented via SAX monitors and a distributed ledger.

### Consensus Driver Routing

In the preceding use case, the state to achieve consensus was around the macroscopic state of the network for external stakeholders. However, many routing protocols privilege responsiveness over consistency. The result is the risk of creating loops and black holes in routing.

However, there are protocols that rely on knowing the actual present state of the network and making routing decisions accordingly. Such protocols would be enabled via a DLT which kept track of the state of the network routing nodes.

A common scenario is routing via Border Gateway Protocol (BGP) between autonomous systems (AS) i.e., networking beacons for a standalone network. The AS's have to track network state sufficient to determine “reachability.” Specifically, the AS's mediate requests to transfer data between their constituent respective networks. Each of the AS's has a unique identifier known as an ASN. An AS generally manages a list of ASNs of AS's that can reach them and a list of ASN's of AS's that they can themselves reach.

These lists can be used to generate potential routing paths that are understood by all nodes as valid paths. These paths, which we can call “consensus paths” may be reported via the DLT node 116. One technique is to report ports via a tri-data structure. Alternatively, other prefix-based techniques such as Burrows-Wheeler graphs may be used as well. In this way, rapid access of state may be achieved.

A side effect of having consensus on state is that mathematical formal methods may be applied to the DLT reported state. As previously mentioned with respect to the network virtualizer 136, this includes application of proving assertions via Coq and/Isabelle, and in general in making static and dynamic assertion checkers via automated proofs.

In this way, where DLT node 116 reports consensus paths, consensus-based routing protocols may be deployed, thereby eliminating black holes, routing loops, and other pathologies from optimistic routing protocols. Another set of advantages in applying mathematical formal methods and automated proofs (e.g., via Bagpipe and similar tools) also become available.

### Example Environment for SDN Utilizing a Contract-Based High-Resolution Network Abstraction

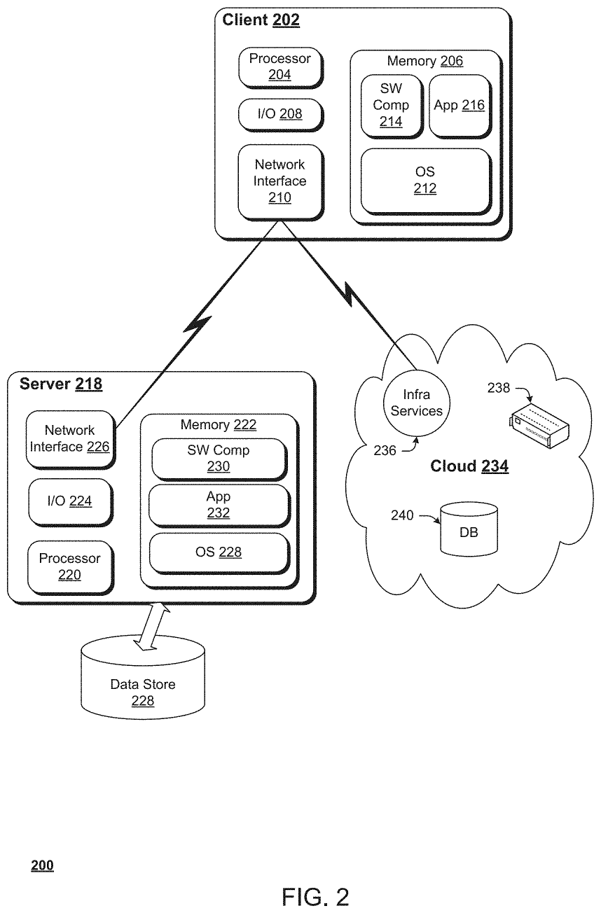

FIG. 2 is a block diagram 200 of a network environment for the SDN that implements contract-based High-Resolution network abstractions. The functionality for contract-based SDN is generally hosted on computing devices. Exemplary computing devices may include without limitation on the client-side: mobile devices (including smartphones), tablet computers, laptops, desktop personal computers, and kiosks. Exemplary computing devices on the server-side may include without limitation: mainframes, physical servers, and virtual machines. Generally, the computing devices are to be networked.

A client-side computing device or “client” for short 202 may have a processor 204 and a memory 206. The processor 204 may be a central processing unit, a repurposed graphical processing unit, and/or a dedicated controller such as a microcontroller. The computing device may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210, may potentially work in concert with the I/O interface 208 and can be a network interface card supporting Ethernet and/or Wi-Fi and/or any number of other physical and/or datalink protocols. Alternatively, network interface 210 may be an interface to a cellular radio.

Memory 206 is any computer-readable media that may store several software components including an operating system 212 and software components 214 and/or other applications 216 including an internet browser or application integrating internet browsing capability. In general, a software component is a set of computer-executable instructions stored together as a discrete whole. Operating systems 212 and applications 216 are themselves software components or integrated aggregations of software components. Examples of software components 214 include binary executables such as static libraries, dynamically linked libraries, and executable programs. Other examples of software components 214 include interpreted executables that are executed on a run time such as servlets, applets, p-Code binaries, and Java binaries. Software components 214 may run in kernel mode and/or user mode.

Computer-readable media includes, at least, two types of computer-readable media, namely computer storage media and communications media. Computer storage media includes volatile and non-volatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), Blu-Ray, or other optical storage, magnetic cassettes, magnetic tape, magnetic disk storage, or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. As defined herein, computer storage media does not include communication media.

The server-side computing device, or “server 218” is any computing device that may participate in a network. The network may be, without limitation, a local area network (“LAN”), a virtual private network (“VPN”), a cellular network, or the Internet. The server 218 has hardware components analogous to the client-side computing device 202. Specifically, the server 218 may include a processor 220, a memory 222, an input/output interface 224, and/or a network interface 226. The memory 222 may include an operating system 228, software components 230, and applications 232. Server hardware 218 differs from client hardware 202 in that processing power is generally more powerful to handle concurrent processes running and network capacity is greater to communicate with multiple clients 202. Server-side software components 230 may include libraries and run-times (e.g., to run interpreted code). Server-side applications 232 may include not only web servers (also called “application servers”) and database servers, but also server software providing functionality. Example server software may include transaction monitors, symmetric access exchange monitors, and machine learning/cognitive network analytics services.

In general, server functionality can be implemented as a software service on a physical server 218. However, such a software service may also be hosted on a cloud 234 via a cloud service 236. Specifically, the cloud service 236 is comprised of multiple physical computer servers which are disaggregated via a hypervisor. Each of the physical computer servers may have one or more processors, memory, at least I/O interface and/or network interface. The features and variations of the processors, memory, the I/O interface, and the network interface are substantially similar to those described for the physical computer server 218 described above.

A cloud service 236 includes a hypervisor that can delegate calls to any portion of hardware in the underlying physical servers, and upon request generates a virtual machine from the separate portions of hardware, regardless of a physical server (a process called “disaggregation”). Just as a physical server 218, a virtual machine may host not only software applications, components including services, but also virtual web servers 238 functionality and virtual storage/database 240 functionality.

Note that virtual machines themselves may be further partitioned into containers, which enable the execution of a program in an independent subset of the virtual machine. Software such as Kubernetes, Mesos, and Docker are examples of container management software. Unlike virtual machines which have a delay in startup due to the need for provisioning an entire OS, containers may be generated more quickly and on-demand since the underlying virtual machine is already provisioned.

In one example, the cloud service 234 embodies an abstraction of services. Common examples include service abstractions such as Platform as a Service (“PAAS”), Infrastructure as a Service (“IAAS”), and Software as a Service (“SAAS”).

### Towards Confirmation of Service Levels Provided Via Verifiable, Auditable Contracts on Distributed Ledgers

### Example Services

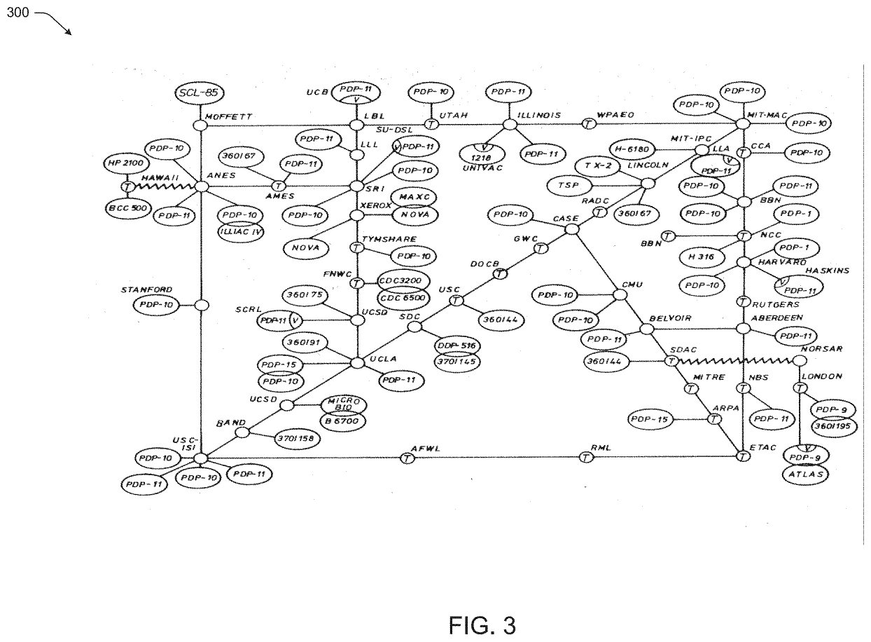

FIG. 3 is an example topology of an Advanced Research Projects Agency Network (ARPANET) 300 that includes the first wide-area packet-switching network service with distributed control. The ARPANET 300 is one of the first networks to implement the TCP/IP protocol suite. Different versions of the specification of the ARPANET 300 have been completed since its establishment by the ARPA of United States Department of Defense in 1960s. In present 5G technologies, high speed, wireless connectivity with an extremely flexible configuration and service architecture is likely to have the same impact over the next 50 years than the ARPANET had over the previous 50 years. Two aspects of the 5G architecture by themselves have the potential to deliver such an impact. One of these two aspects is network slicing.

The prospects of network slicing, i.e., executing multiple logical mobile network instances on a shared infrastructure, may require a continuous reconciliation of customer-centric SLAs with infrastructure-level network performance capabilities. Service customers, e.g., from the vertical industries, may request the creation of (tele)communication services by providing “customer-facing” on-demand service requirement descriptions to Service Providers. In the past, operators executed such mapping in a manual manner on a limited number of service/slice types (mainly mobile broadband, voice, and SMS). With an increased number of such customer requests, an E2E framework for Service Creations and Service Operations will therefore have to exhibit a significantly increased level of automation for the lifecycle management of network slice instances.

Another impact of the 5G architecture is the multiple-access edge computing. In one example, the Mobile-edge Computing such as the MEC cluster 114 of FIG. 1, may provide IT and cloud-computing capabilities within the Radio Access Network (RAN) in close proximity to mobile subscribers. For application developers and content providers, the RAN edge offers a service environment with ultra-low latency and high-bandwidth as well as direct access to real-time radio network information (such as subscriber location, cell load, etc.) that can be used by applications and services to offer context-related services. These services are capable of differentiating the mobile broadband experience.

The two impacts above jointly proclaim that services are just about anything for which a vendor might plausibly collect revenue. Moreover, because the services themselves are supported on the edge of the network, they may be confined to a small volume of space—within a building, say. Finally, because the consumer of the service is mobile, the time interval during which the consumer is within the designated space may be quite limited. Insofar as the SLA is specified as being in effect within the confines of a volume of space and an interval of time, those confines are potentially very small. At some point the generation of SLAs has to be completely automated, else the sales opportunity will have come and gone while waiting for a geologically-paced human decision. Having accepted the automation of SLA creation, a complementary construct is immediately required: a service level proof (SLP). An SLP is irrefutable evidence that the service promised was actually delivered. In one embodiment, the aforementioned SLAs and SLPs are best materialized in ecology of verifiable, auditable contracts whose performance is traced on distributed ledger technology.

### Example Toy Symmetric Asset Exchange Contract

Traditional legal contracts entail an exchange of “consideration.” As described in implementations herein, the “consideration” may be understood to be an asset of some sort. Having adopted such a perspective, we may understand digital payment systems and digital logistics tracking systems, for example, to be performing digital asset exchange contracts involving specifically characteristic patterns of exchange.

In one example, a digital asset exchange contract definition may include a collection of processes given in a suitably chosen process calculus—specifically, the asynchronous π-calculus with joint inputs. There we provided a syntax together with operational semantics for the calculus—which semantics is readily representable on distributed ledgers. The aforementioned calculus also has a restricted version—built around symmetric asset exchange (SAX), an internally definable process pattern caramelized in a bit of syntactic sugar—with which we equip a categorical semantics suitable for interpreting process dynamics in a (categorical) relational database. In so restricting, we give up the Turing completeness of the larger process calculus. This loss of expressive power may have no practical impact on the modeling of actual commercial contracts as digital constructs, especially as they are given just in time embodiments on distributed digital ledgers with faithful reflections in relational databases. It will also be the case that these restricted contracts are verifiable via model checking.

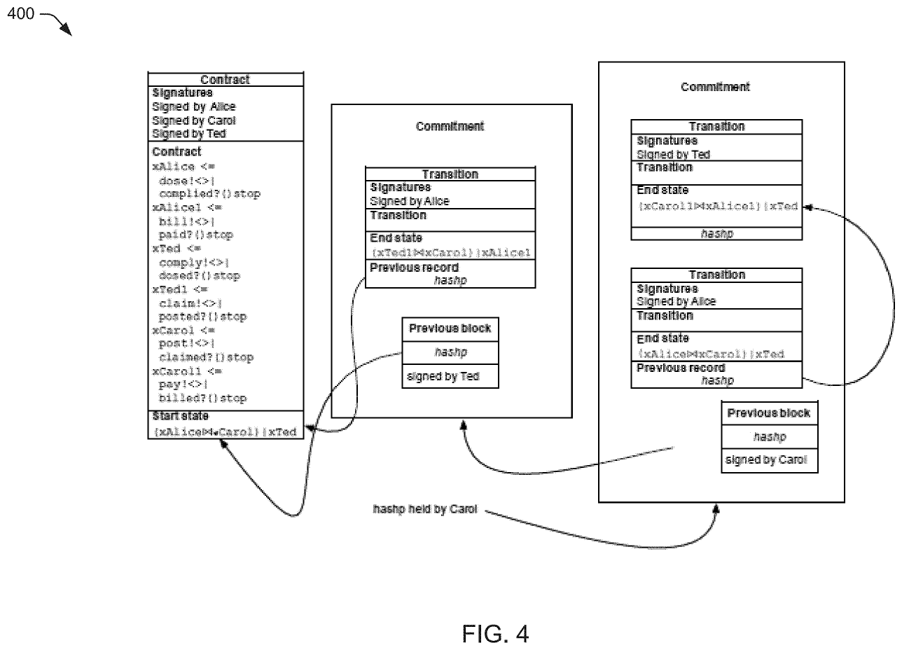

FIGS. 4-6 illustrate a formalization of a contract and symmetric asset exchanges among parties. In one example, FIG. 4 illustrates a sequence 400 encoded on a blockchain. Sequence 400 illustrates initial transitions chronicled on a ledger. Described below is an example toy symmetric asset exchange contract between Alice, Carol, and Ted as parties to the contract. For example, Alice is a health care provider, Ted is a patient and Carol is a payer. An example terms of the contract are Alice and Ted exchange a single dose of treatment for an acknowledgment of compliance with treatment; Ted and Carol exchange a claim of treatment for an acknowledgment of posting of the claim; and Carol and Alice exchange payment for a bill followed by repeating.

Following the example above, the formalization of the clauses of their contract consists of:

```
xAlice ( dose , rx , rcv ) <=
  dose ! <rx >| rcv ? (rxcredit )
xAlice 1xAlice 1 ( bill ,payin,
rxcredit ) <= bill !<rxcredit > |
payin ? ( cash ) xAlice
x Carol ( payout ,
demand , fee ) <=
payout ! <fee >
  | demand ? ( chit ) x
  Carol xTed (
  treated , rxpay ,
  comply ) <=
  treated ! <rxpay
  > | comply ? ( meds
  ) xTed
```

The complete contract is a composition of session sequences with cascades of contract clauses include:

```
( xAlice ( dose , complied ) [symbol]     xAlice 1 (
  bill , paid ) ) * | ( xTed ( comply ,
  dosed ) [symbol]     xTed1 ( claim , posted ) ) * |
    ( x Carol ( post , claimed ) [symbol]     xCarol ( pay , billed ) ) * |
( ( dose , comply ) [symbol]     (
  complied , dosed) [symbol]     (
  claim , post ) [symbol]     (
  posted,claimed) [symbol]
    ( pay , bill ) [symbol]     ( billed , paid ) ) *
```

The operational semantics for our contract language gives rise to a labeled transition system for Alice, Carol, and Ted, some of whose initial transitions are presented in the following sequence:

```
(xAlice [symbol]     xTed ) | xCarol →
  (xTed1 [symbol]     x Carol ) | xAlice1 →
    (xCarol1 [symbol]     x Alice1 ) | xTed →
      (xAlice [symbol]     xTed ) | xCarol → . . ...
```

Because such a sequence of transitions is intrinsically transactional, we may naturally encode the sequence on a blockchain as is illustrated in FIG. 4. As the labeled transition system of this contract is cyclic, the blockchain record of execution, in principle, goes on forever. Each record in this chronicle will be related to every other record via the syntax and semantics of the contract itself. In other words, the contract schematizes the relationships. It is those relationships, rather than the data itself, that frames the audit trail.

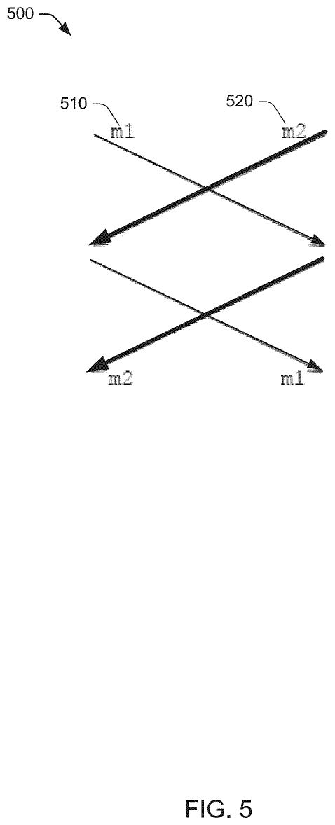

As already mentioned, just in time contracts (JITCs) are built around the SAX construct, indicated by “M”. The SAX construct should be understood as a kind of transactive message forwarder where two or more messages (e.g., message 510 and message 520) are “simultaneously” received from their respective origins and re-sent in parallel to their respective destinations. This construct is presented graphically in FIG. 5, which is a sequence 500 that illustrates the symmetric asset exchange as message forwarding. While the SAX construct was originally conceived to enable synchronous message sending in a fundamentally asynchronous process calculus, “M” has additional useful properties. Most particularly, it serves as a basis for the ledger-equivalent of a transaction monitor in a relational database.

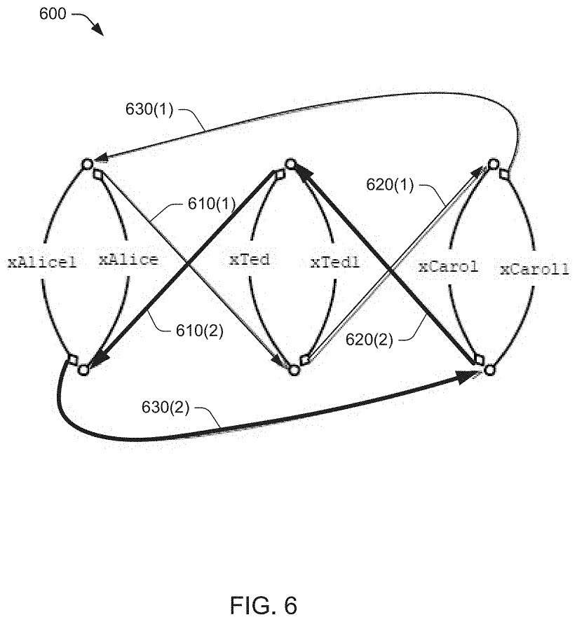

FIG. 6 is an example sequence 600 symmetric asset exchanges among Alice, Carol, and Ted as parties to the contract following the example above. FIG. 6 shows the (cycle of) symmetric asset exchanges, occurring in Ted's chronic treatment, with each pair of arrows constituting an exchange. For example, the pair of arrows includes arrows 610(1) and 610(2), 630(1) and 630(2), and 630(1) and 630(2). Such exchanges may be regarded as completed transactions relevant to digital contracts.

Apparent in both FIGS. 5 and 6 above is that the contract parties emerge as vertical columns and that the exchanges between them are evidenced as (vertical) sequences of pairs of arrows. The sequences of arrows are formally defined as session sequences. A party, in turn, is formally defined as a cascade of clauses. Session sequences, in fact, constitute a kind of interface between pairs of parties. As it happens, part of the formal semantics of contracts is a mathematical construction called simulation by which it is possible to determine if an arbitrary process adheres to an interface. Indeed, as long as a computation correctly simulates an interface, we are completely indifferent to whatever else that computation may be doing. Said another way, JITCs call out how parties must interact. Parties may be doing other things “behind” the interface.

Accordingly, we have presented Alice, Carol, and Ted as if they were interacting directly via messages chronicled on a distributed ledger. Much more likely, their respective computational agents are interacting on their behalves. A more realistic account of what might actually be happening is that Alice, a physician employed by the Oregon Health Sciences University, has her clinical practices orchestrated by OHSU's Epic system. Carol, an insurance claims processor for Aetna, is guided through the claims process by Aetna's installation of BizTalk Server. Finally, Ted interacts with Alice via his MyChart iPhone patient app and with Carol via his Aetna insuree app.

### Label Switching Histories

Control, management, administration, and governance of packet-based digital communications networks require detailed accounts of packets' travels through such networks. Thus, a framework is described herein within which to keep such accounts. Nominally, this framework depends on the networks' being architected as multiprotocol label switching (MPLS) systems. That is only superficially the case: communications networks may be understood as topological constructs. From that perspective MPLS labels may be understood as giving names to the open sets of some underlying topology. The topology may be on the physical network, the virtual network or—even—the information transmitted over the network. Moreover, to traverse a space (physical or conceptual) with a topological structure is to enter and exit possibly nested open sets. It is natural, therefore, to organize entrances and exits into a push-down stack structure. We begin our development of label switching histories with a concrete data structure. We then reimagine that data structure as a database. Finally, we show how both the original data structure and the database can be presented transactively in a distributed ledger.

### As Materialized Data Structures

A directed tree is a connected graph having a distinguished root node from which there is a unique (directed) path to every other node in the tree. The nodes immediately reachable from a given (parent) are its children. We are interested in ordered trees such that there is a total “horizontal” order on the children of a node which we will understand as “younger than”. Obviously, the children of a parent node are younger than the parent. Unlike families, however, we require that all the children of a younger sibling be younger than each of the children of an elder sibling. The net effect is that the nodes of our ordered trees are totally ordered. If a tree is presented on a page, we will understand “younger” as going from top to bottom and left to right. This total order on nodes induces a total order on the branches of the tree. From left to right we shall understand the branches as getting younger.

We will mark each of the non-root nodes of an ordered tree with labels from some distinguished set of MLPS labels, “ [symbol] ”, ranged over by “|”. In this regard, the root is understood as corresponding to a packet (or asset) being labeled. A marked, ordered tree is well-marked if no label, “|”, marks more than one node. Insofar as labels correspond to routing paths, multiple occurrences of labels would indicate loops. As relay network loops are deemed undesirable, we shall assume that they do not occur.

Let R be a distinguished set of router names, ranged over by r. We posit a collection of actions, {push(r)|rϵR}∪{pop(r)|rϵR}. An action decoration is one of push(r), an initialization, or push(r), pop(r′), a finalization. A tree will be termed decorated if every edge is assigned an action decoration. A decorated, ordered tree is well-decorated if each of the following conditions obtains: 1) A given router, r, occurs at most once among all decorations except in the case of immediate sibling nodes where the elder may be decorated push(r), pop(r) and the younger may be decorated either push(r′), pop(r″) or just push(r′) for distinct r, r′, r″. Such occurrences will be understood as the equivalent of a virtual action, switch(r′); 2) If any edge leading from a node to one of its children is an initialization, the child must be the youngest; 3) If some edge is decorated with push(r), then each edge above it is decorated with an action decoration push(r′) for some r′ [symbol] r; 4) If some edge is decorated with push(r), pop(r′), then every edge below it is decorated with push(r″), pop(r′″) for some r″ [symbol] r, r′″ [symbol] r′.

An MPLS history is any well-marked, well-decorated ordered tree. We may consider all possible such histories for a message. There is obviously a partial temporal ordering of MPLS histories. Moreover, every pair of comparable histories is separated by a finite number of histories. Consequently, every history is immediately adjacent to at least one other history.

Given a packet moving through an MPLS network, for each point in time there is an MPLS history that records every stack of labels that a packet has had thus far. For a packet delivered from origin to destination, there is a final MPLS history that is a complete record of its travels, understanding that the only things routers may do to labels are to push, pop and switch them.

A packet-based communications network may be understood as a dynamical system, the particles of which are packets. Students of dynamical systems typically wish to picture the orbits of systems' particles, accounting for both the positions of such particles at any given time as well as the forces to which those particles were subject. An MPLS history may be understood as a packet orbit.

### As Databases

An MPLS history mentions some set of routers. Each router visitation (which is unique) can be understood as a point in time. In that regard, an MPLS history is a database whose key-values are routers. In the context of such a database, the keys are totally ordered by the depth first left first traversal of the totally ordered tree. Each push decoration corresponds to the downward traversal of an edge. Each pop decoration corresponds to an upward traversal of an edge. As noted above a pop action and a push action that share a router are understood as an MPLS switch action. Understanding an MPLS history as a database, it is useful to think of it as a collection of records each of whose key fields contains a router identifier. We may think of such a record as containing 3 other fields: an action (one of push, pop, or switch), an “in” label, and an “out” label. Sorting this database on various fields together with the usual relational algebraic operations can answer all manner of questions, e.g., What was the label stack of the packet when arrived at a particular router? Nonetheless, the database as it stands is somewhat impoverished. We can imagine augmenting a record with other fields—an inbound time stamp and an outbound time stamp, for example. Such a pair of times would be useful in calculating such metrics as the bill, quality of service, and network overhead. Needless to say, such augmentations of the record schema would need a corresponding amendment to the notion of decoration elucidated in the previous section.

As noted in the previous section, there is a partial order on all possible MPLS histories for a given message. For a history, H, which is the immediate successor of the history, H, we may consider H′ to be the consequence of an update to H. When looked at as databases the two will differ by the addition of exactly 1 new record. As such, these databases are purely cumulative. Insofar as H and H′ may be thought of as related by an update transaction, the transaction model is particularly simple. Since only one router “has” a message at a given time, history updates are both deterministic and independent of any notion of precondition.

In the context of a database understanding of histories, it may be useful to consider multiple messages. In that case, we may wish to amend our notion of a record with a message identifier field. A record key then becomes the message/router pair. This is a particularly useful perspective in the Deixis realm of mirroring distributed ledgers on relational databases.

### As Transaction Logs on Distributed Ledgers

A distributed digital ledger is usually understood to be a totally ordered and immutable sequence of transactions, allowing the addition of new transactions. We will take the transactions to be with respect to an MPLS history. Having as we do both data structure and database deconstructions of such histories, this suggests at least two distinct ways of representing transactions on ledgers.

In the case of the data structure, update transactions may be thought of as either adding a new edge with a push decoration or adding a pop decoration to an existing edge. There are integrity constraints on both these kinds of transactions necessitated by the definition of an MPLS history as a family of data structures. One obvious way of enforcing such constraints is by mediating all updates with contracts validated as guaranteeing such enforcement.

On the other hand, we might take the database view of an MPLS history. In this case, the integrity constraints are particularly simple, as a transaction can only add a new record whose key field must be a “fresh” router and all other fields are subject only to data type constraints. Of course, if there were fields other than those posited for the base case above, there could conceivably be other kinds of integrity constraints as well.

### Digital Communications Network Configurations as Operads of Wiring Diagrams

Described in sub-sections below include operadic framework for specifying digital communications network configurations. This framework accommodates connectivity which may be directed, undirected, unilateral, bilateral, or multilateral. The framework also specifically addresses structural nesting and nesting boundaries and the ways in which connections may cross those boundaries.

Digital communication networks are composed of constituents whose semantics—e.g., “endpoint”, “switch”, etc. may be of interest in their own rights. As described herein, semantics can be imputed via algebras on wiring operads. Such algebras amount to “typing” in the usual programming language sense of the term. Further, compositional structure of wiring operads can be exploited to encode wiring diagrams on distributed ledgers.

### Undirected Wiring Diagrams (UWD): Network Connectivity and Configuration

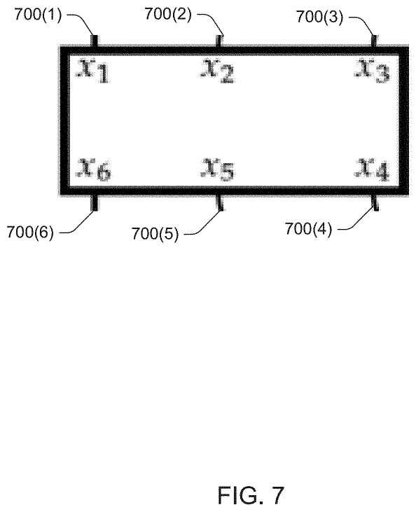

FIGS. 7-16 illustrate example implementation of using undirected wiring diagram to model configurations of digital communications network and using of directed wiring diagrams to model the forwarding tables controlling packet forwarding in digital communication networks. Referring to FIG. 7 that includes an example “empty” box, we take boxes as the objects of the operad of undirected wiring diagrams, of which FIG. 7 is a visual exemplar. At the edges are “connection pins”, x1 700(1), x2 700(2), etc. While the visual presentation appeals to intuition, as a mathematical construct, X1 is just its sequence of connection pins. That is to say, X1={x1, x2, x3, x4, x5, x6}. In fact, the mathematical definition of a box is such that each distinct box has uniquely named pins, each of the latter being assigned a color from a class of colors, S.

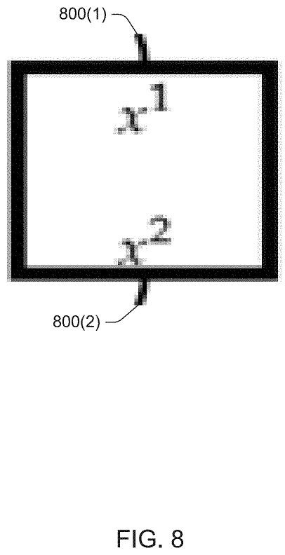

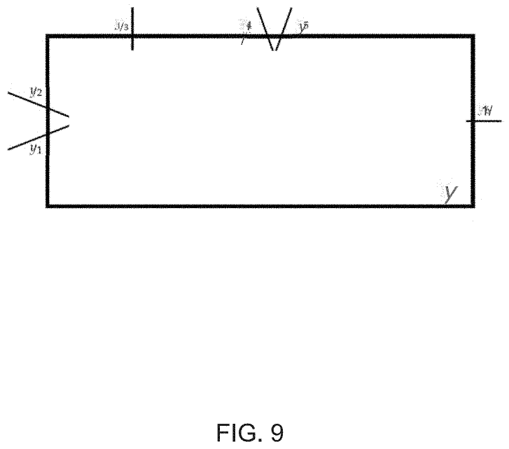

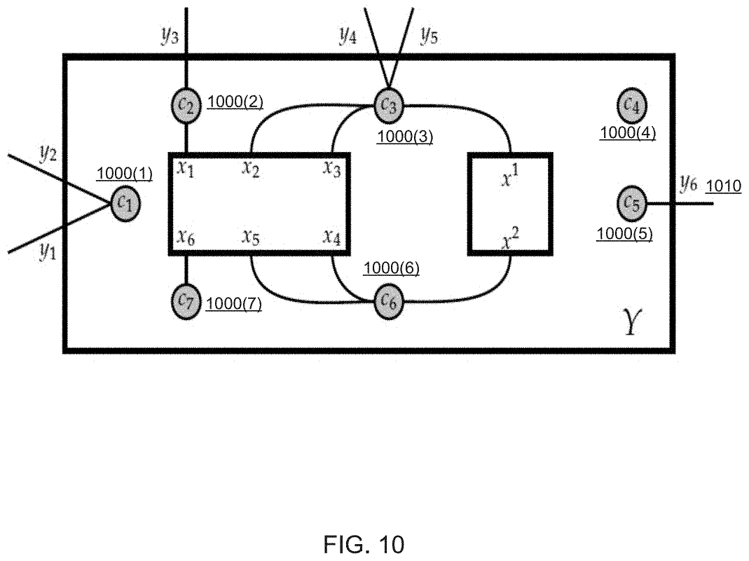

Referencing a second box in FIG. 8 that includes an “empty” box, X2={x1 800(1), x2 800(2)} and Y={y1, y2, y3, y4, y5, y6}. We wire together X1, X2 and Y to create an undirected wiring diagram—visualized in FIG. 10—formally, a morphism of the operad of undirected wiring diagrams. FIG. 9 is another example of “empty” box, Y. To begin with, X1 and X2 are now nested within Y. Moreover, there are some new players, c1 1000(1), c2 1000(2), etc. that may represent “cables.” The idea is that cables are used to interconnect the pins of X1, X2, and Y. In that regard they are intermediaries. Notice, however, that some pins—e.g., y6 1010, while connected to a cable are not, in turn, connected to any other pin. The cable, c4 1000(4), is completely disconnected. The cable intermediaries allow us to construct any pattern of connection among pins we might like.

In basic category, theory morphisms relate objects. A morphism, f, from object, A, to object, B, is typically denoted f: A→B. We might use φ to name the morphism that is the undirected wiring diagram of FIG. 10, where boxes X1 and X2 wired into the box Y, resulting in the undirected wiring diagram, φ. Then φ: X1, X2→Y seems an appealing analogue to the categorical notation. Further emphasizing the analogy between operads and basic categories, we may understand the class of morphisms—the “hom-set”—between X and Y to be denoted UWD(Y). The hom-set notation will be useful when we consider functors between operads.

We may informally understand an undirected wiring diagram such as the mor-phism, φ, to comprise a number of elements: An output box, Y; Zero or more input boxes, X, possibly explicitly enumerated as we did above with X1, X2; A (possibly empty) collection of cables such as the cables 1000 above; A function from the set of pins of the output box, Y, to the set of cables 1000; and A function from the collective set of pins of each of the input boxes represented by X to the set of cables where a connecting pin and the cable must both have been assigned the same color from S

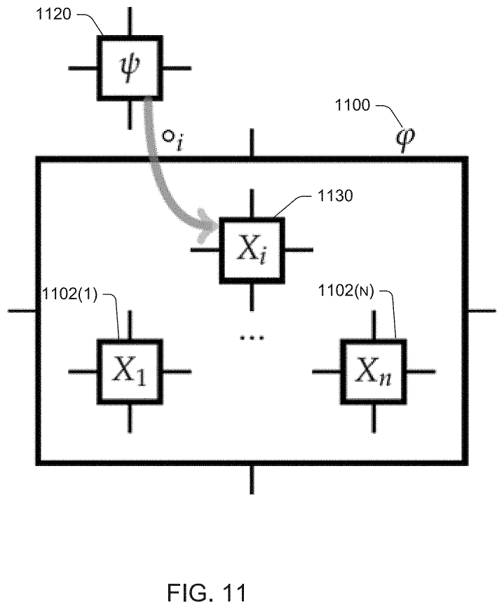

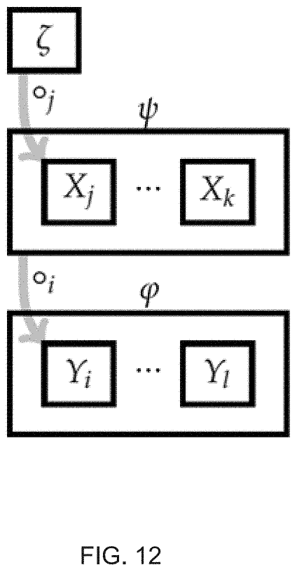

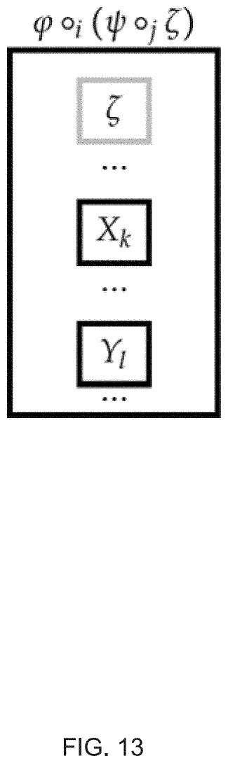

It can now be pointed out that the characterization of undirected wiring diagrams above only accounts for one level of nesting. One may, therefore, ask how one gets more than one level. The answer is by the composition of undirected wiring diagrams. Imagine that we have two such diagram, φ 1100: X1 1102, . . . , Xi, . . . , Xn 1102(n)→Y and ψ 1120: Z→Xi. The composition of ψ 1120 with φ 1100 along φ's i'th input, denoted φ ∘i ψ, is suggested by FIG. 11. Xi 1130, of course, represents the first level of nesting. The second level of nesting can be found by looking at the input boxes of ψ. Of course, composition can be iterated arbitrarily as is indicated by FIG. 12. Alternatively, or in addition, compositions may be evaluated as shown in FIG. 13. An evaluation has two consequences. First—as one might expect, evaluation flattens layers of nesting. Second, evaluation eliminates redundant cables. There is no reason ever for a single pin to be connected to two cables either directly or indirectly.

Undirected wiring pictograms may be completely formalized—both in their structural hierarchy and in their connectivity—by undirected wiring diagrams. But the reader should not imagine that such formalization is limited to digital communications networks. Imagine, for example, the structure of a collection of software modules with their declarations of importation and exportation. That sort of structure is representable as well. Whatever is represented by undirected wiring diagrams, the compositional semantics of such diagrams allows the flattening of structures.

### Directed Wiring Diagrams: Network Control

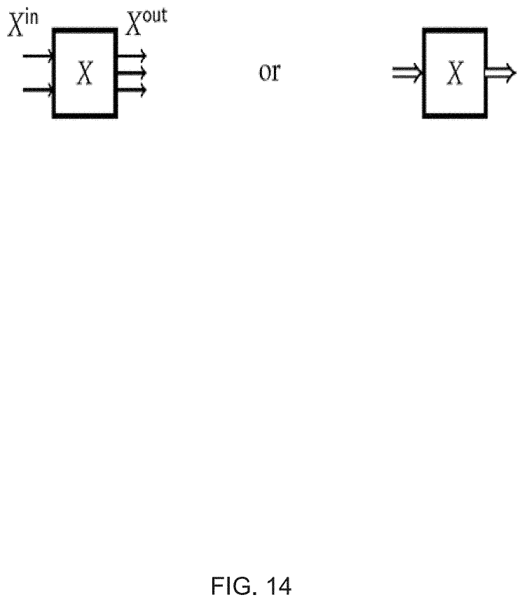

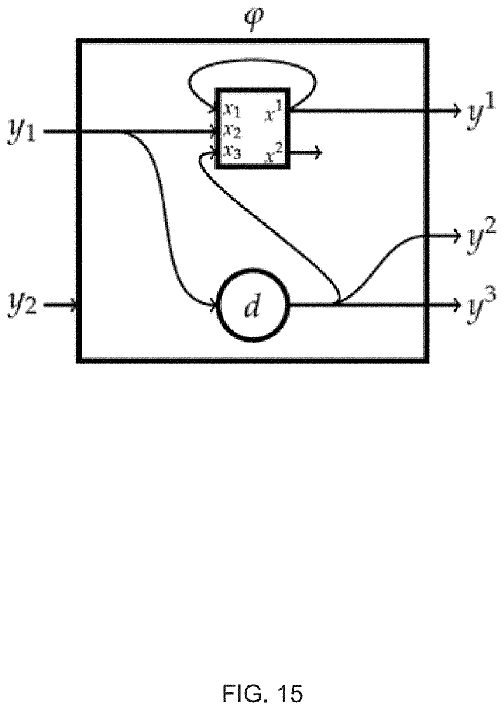

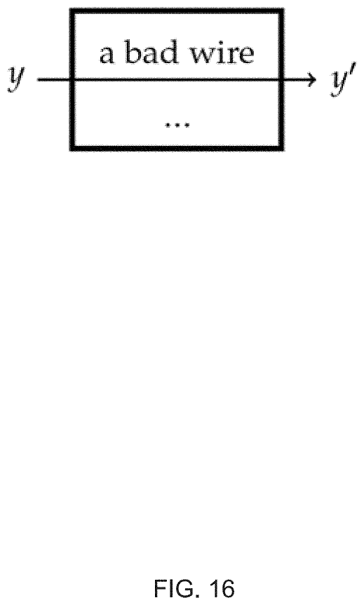

As is made evident in FIG. 14, the pins of boxes are partitioned into “in” and “out”. What we also failed to say is that insofar as undirected boxes have pins, they only have out pins. In that regard, the boxes of the operad, UWD, are a sub-class of the boxes of WD, the operad of directed wiring diagrams. We see the utility of this partition illustrated in the directed wiring diagram of FIG. 15 whose output box we will understand to be Y and whose input boxes consist solely of the one visible interior box which we shall designate X. The respective in pins and out pins of X are Xⁱⁿ={x₁, x₂, x₃} and X^{out}={x¹, x²}. The respective in pins and out pins of Y are Yⁱⁿ={y₁, y₂} and Y^{out}={y¹, y², y³}. In undirected wiring diagrams pins were always connected via intermediary cables. In FIG. 15, we see direct connections between pins—for example, the in pins, y₁ and x₂. We also see something new in the guise of the delay node, d. Directed wiring diagrams are fully intended to embody a model of causality. In that regard, FIG. 16 is not a legal directed wiring diagram. In the first instance, why should one create such a vacuous diagram, as its only function is apparently to reproduce its input as its output? Its illegality, however, is a consequence of mapping its input to its output instantaneously. Vacuous mappings are, in fact, permitted. They simply cannot be done instantaneously. Hence, we have the delay node in FIG. 15. Out nodes y² and y³, are, indeed, just copies of the in node, y₁, but they are delayed copies.

Box pins and delay nodes are also divided into demand wires and supply wires. In the wiring diagram of FIG. 15 {y₁, y₂, x¹, x², d} are the supply wires of φ and {x₁, x₂, x₃, y¹, y², y³, d} are demand wires of φ. A key thing to notice is that a delay node is both a supply wire and a demand wire of φ. If a supply wire is connected to anything at all in φ, it is a demand wire. If a demand wire is connected to anything at all in φ, it is a supply wire.

We may informally understand a directed wiring diagram such as φ to comprise a number of elements: An output box, Y; Zero or more input boxes, X; A (possibly empty) finite collection of delay nodes, DN; A function from DN to the class of colors, S; A function from the disjoint union of the input wires of the output box, Y, the output wires of the input boxes, X, and the delay nodes, DN to the disjoint unions of the input wires of the input boxes X with the delay nodes, DN.

Directed wiring diagrams, of course, constitute the morphisms of the operad of directed wiring diagrams, WD. In a fashion similar to that adopted for UWD,

$$WD ( \begin{matrix}Y \\ \underline{X}\end{matrix} )$$

constitutes the class of morphisms from X to Y in WD.

### Algebras on Wiring Diagrams: Network Semantics

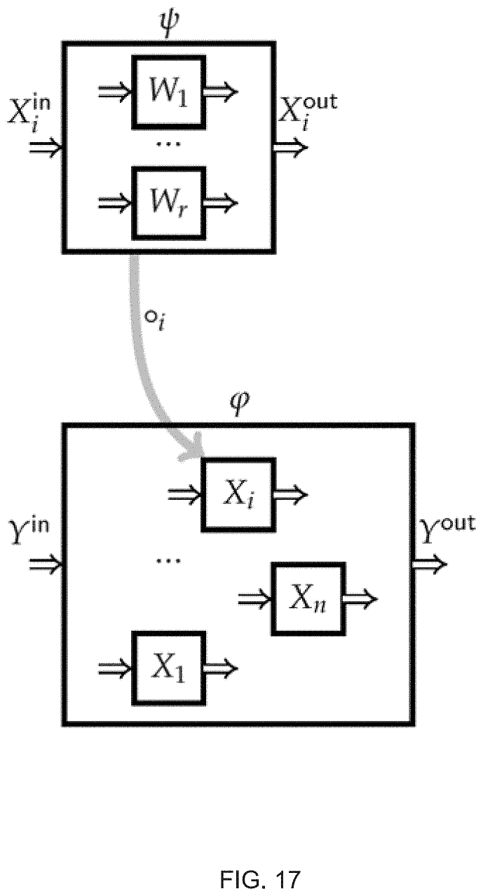

FIGS. 17-21 illustrate an example implementation of using mathematical algebras on directed and undirected wiring diagrams to model network properties. Before getting to algebras on wiring diagrams we must first consider functors on operads. Most of the body of work that constitutes pure basic category theory is a study of functors such as, F: C→C¹, which is structured mapping that takes each object, C, of the category, C, to an object F (C) of the category, C¹ and which takes each hom-set, C(C₁, C₂), to the hom-set C¹(F (C₁), F (C₂)) of C¹ in such a way that the morphism compositions of C are respected by F. We define a functor, G: O→O¹, on operads, O and O¹, analogously. There is an additional wrinkle though. As

$$C ( \begin{matrix}Y \\ \underline{X}\end{matrix} )$$

has an “arity”, |X|, we require that |X|=|G(X)|. We have already noted that there is a wiring diagram in WD corresponding to FIG. 7 and a wiring diagram in UWD corresponding to FIG. 8. None too surprisingly, there are operadic functors between WD and UWD in both directions.

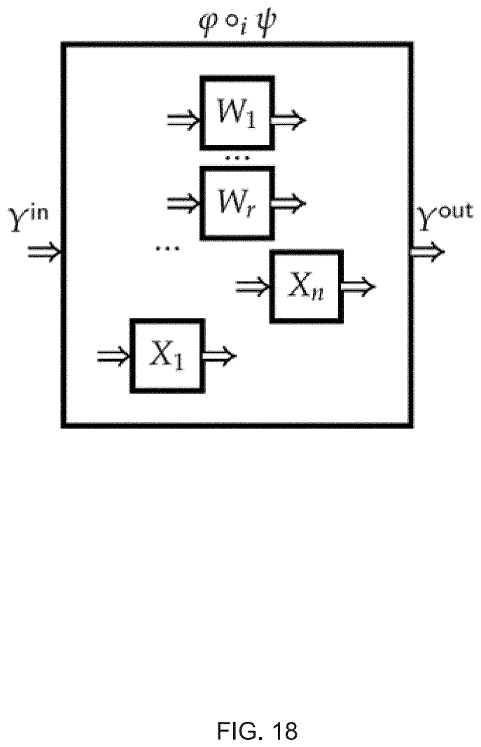

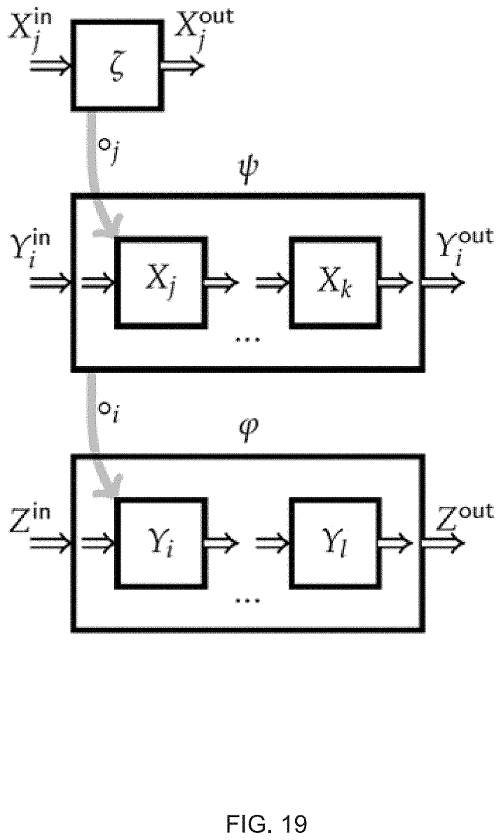

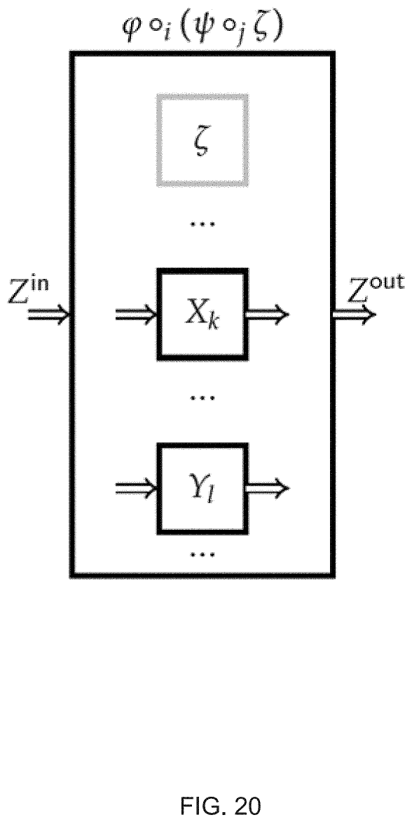

FIG. 17 illustrates the composition of ψ with φ in the operad WD. Just as was the case with UWD such compositions may also be read as the introduction of an additional level of structural nesting. Also, as was the case with UWD, compositions can be flattened in WD as is indicated in FIG. 18. Needless to say, composition and flattening can be iterated ad nauseum as is indicated by FIGS. 19-20.

While our primary application interest in directed wiring diagrams is to formalize forwarding in networks, diagrams in WD may be usefully employed in other realms. Two that come to mind are inter-module calls among programming language modules (such as those which might implement an SDN) and a hierarchically structured supply chain along which one might track the flows of goods and services.

In basic category theory, an algebra on the category, C, is any functor from C to the category of sets, Set. The utility of algebra is this: We can develop a purely abstract category that gives a complete characterization of the theory of groups, say. Any particular group will be given by a functor from the abstract category to Set. Such a functor is understood to give semantics to the theory that is the category. It turns out that, not only is Set a category, it also enjoys the structural properties required of an operad. By analogy, therefore, the operad functor, F: O→Set may be understood as an algebra on the operad O. There is another category of interest, Rel, whose morphisms—rather than being functions between sets—are relations between sets. Because of the usual relation between functions and relations, there is a faithful embedding of Set in Rel. As it happens, Rel also has the structure of an operad. A functor of the form G: O→Rel is a relational algebra on O.

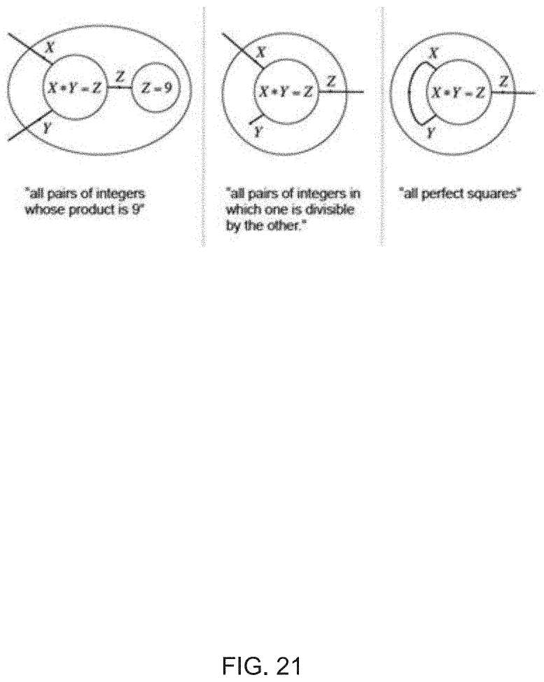

Algebras and relational algebras on UWD and WD provide a mathematically rigorous way to impute semantics to otherwise completely abstract diagrams. For example, we may think of algebraic equations as objects in Rel. Indeed, FIG. 21 depicts several objects in Rel presented in such a way as to evoke objects in UWD. Thus, we can conceive “cost functors” from UWD to Rel which basically associate equations with morphisms and “unknowns” with wires. We will understand an equation as calculating the cost (alternatively, benefit) for a packet traveling along with the corresponding wiring diagram. If a chosen cost functor always yields equations with single unknowns on one side, we will understand the equation as calculating the cost/benefit of exiting along that wire. With that model in mind, we can choose a cost/benefit functor in such a way as to calculate the cost of traversing a particular path in an undirected wiring diagram. Typically, forwarding is decided by choosing the least cost (alternatively, most benefit) paths with respect to some model of cost. We now have at our disposal the means to model cost/benefit as specified by any (numerical) equational system. Once an acceptable cost/benefit functor is chosen, there is an obvious relationship between the undirected wiring diagram and an implied (by cost/benefit) directed wiring diagram.

Before leaving the topic of algebras and relational algebras, let's imagine their use for a quite different purpose. We could use an undirected wiring diagram to represent an interdependent system of program modules (dependency graph) where the wires represent exports from the contained input boxes (sub-modules) to the containing output box (module). We could equally well use a directed wiring diagram to represent the call structure (call graph) among modules. Via suitably constructed functors we could map either of the wiring diagrams to Set where the sets were files and the functions were chosen to map positions in files. Needless to say, there are functors that take the undirected wiring diagram of network structure to either operad of dependency graphs or the operad of call graphs. It should be apparent that we could code and configuration management of an SDN to an entirely operadic framing.

### Wiring Diagrams on Blockchains

Heretofore we have emphasized the use of both undirected and directed wiring diagrams as vehicles for representing assembly structure and connectivity structure in various technical artifacts—but most especially, in digital communications networks. At the outset, we noted a number of challenges presented by digital communications networks in the face of 5G and software-defined networks arising from their static and dynamic structural complexities. As both 5G networks and SDNs are likely to be spatially and administratively distributed, distributed ledgers seem a natural vehicle for immutably documenting present and past network configurations. If we take Hyperledger Fabric as a representative implementation of distributed ledgers, we can imagine four attribute/value pairs being stored:

First, undirected wiring diagram: the 2-level description of network connectivity; second, undirected wiring assembly: a multi-level composition (which evaluates to the previous 2-level description) of wiring diagrams describing the network hierarchical structure; third, directed wiring diagram: the 2-level description of network forwarding, and fourth, directed wiring assembly: a multi-level composition (which evaluates to the previous 2-level description) of wiring diagrams describing network for-warding.

The attribute/value pairs above provide an exact description of the current digital communications network as wiring diagrams. Moreover, Hyperledger Fabric can easily provide such descriptions—both current and past. While the history of such wiring diagrams tells us something about the dynamics of network evolution, it does not tell us much about the “how” or the “why” of such an evolution. There is a body of formal results about undirected and directed wiring diagrams which we can exploit (and record on the ledger) which allow the tracking of dynamics in a much more informative way.

One way to look at the assemblies above is that they are “factorings” of wiring diagrams. This is actually the case in a quite profound way. First, we need to be explicit regarding an aspect of wiring diagrams which heretofore we have made implicit use. Suppose there was a wiring diagram of which we would like to have distinguishable copies. If we have two diagrams that were the same except for the names on their pins, we have, in effect, two copies of the same diagram. The second diagram is gotten from the first by a name substitution. If the first diagram appeared in a composition of diagrams and we did the same substitution on the composition, the two compositions would evaluate to the same 2-level diagram modulo the aforementioned substitution of names. We can think of this name substitutability as a kind of polymorphism in names.

Recall, that each pin (and cable and delay node) has a color. Much as name polymorphism is an identity between wiring diagrams by substitution of names, we can think of color polymorphism as an identity between diagrams by a (structurally consistent) substitution of colors. It is therefore useful to think of a wiring diagram schema in which we imagine node variables (for which we can substitute explicit names) and color variables (for which we can substitute explicit colors). Here are two amazing facts: every undirected wiring diagram is a composition of instances of exactly 6 undirected wiring diagram schemas; every directed wiring diagram is a composition of instances of exactly 8 directed wiring diagram schemas.

In other words, every wiring diagram (whether directed or not) can be factored into primitives from a fixed, finite set of schemas. Composing instances of the above-mentioned schemas to generate a wiring diagram can be presented as mathematical proof. As wiring diagram composition enjoys associativity properties, there can be more than one such factoring into primitives because the composition can take place in different orders. But not to worry since given two factorings of an undirected wiring diagram, the first factoring can be mapped to the second by the repeated use of 17 equations; given two factorings of a directed wiring diagram, the first factoring can be mapped to the second by the repeated use of 28 equations.

Applying the above-mentioned equations makes refactoring an explicit mathematical activity that can be presented as mathematical proof. It is our opinion that well-managed information systems evolve in a sequence of steps consisting either of the replacement of a factor—otherwise maintaining the ambient factoring—or refactoring of the existing components. This observation suggests a more revealing use of the blockchain: The attribute/value pairs proposed above consist in a directed or undirected wiring diagram and factorings thereof. Suppose we instead (in both directed and undirected cases) stored the previous wiring diagram, the operating factoring of the previous diagram, the refactoring of the previous diagram, the current wiring diagram, and a factor substitution by which to construct the current diagram's factoring. As already mentioned, wiring diagrams are related to factorizations by proofs. Similarly, pairs of factorizations are related by proofs. One might choose to record those proofs on the blockchains as well as recording the conclusions of such proofs. With or without proof, the combination of the previous diagram, previous factoring, current diagram, and current factoring would provide deep structural insight into system evolution. Apart from decorating those attribute/value pairs with proofs, one may choose to decorate the values with additional metadata—like the signatures of the system administrators and system engineers who made the changes. In any event, this factoring-based elaboration would permit framing a detailed account of the how and why of the current network configuration.

### Bringing it all Together

Thus far, discussion of the high-resolution contract based wireless network virtualization has focused on different aspects. It may be worthwhile to discuss a particular implementation. Here we discuss the components around an application towards cellular network for the wireless network. Here, high-resolution means that there is a smallest node in the network, called an atomic node. An atomic node may be a physical node in a cellular network such as a switch, or it may be the smallest virtualized node such as in a set of nodes as defined by Multiprotocol Label Switching (MPLS). For purposes of location types, atomic nodes are said to be at the atomic level.

A node or a set of nodes may define a location of a packet. Accordingly, locations may have a location type that defines the level of abstraction by which the wireless network is viewed. In the case of a cellular network, there is a location type of atomic nodes. As a next level of abstraction up, there is a location type of groups of atomic nodes within the same Border Gateway Protocol (BGP) Autonomous System (AS) domain. As a next level of abstraction up, there is a location type of the Border Gateway Protocol (BGP) Autonomous System (AS) domain itself

With these preliminaries out of the way, we can turn to configuring a high-resolution contract based wireless network virtualization for a cellular network. For discussion purposes, we call this a Cellular HRCBV short for cellular high-resolution contract based virtualization.

The Cellular HRCBV receives at a network scheduler of the cellular network, a network abstraction of at least part of the cellular network comprised of nodes and connections between the nodes. The nodes may change over time. The connections between the nodes may change over time.

The Cellular HRCBV then receives at a network scheduler a first routing history for a first packet located at a first node and a second routing history for a second packet located at a second node. The network scheduler then identifies via a consensus based network routing algorithm a location subsequent to the first node to route the first packet to, based at least on the first node and the second node being in consensus as to the location of the first node and the location of the second node. The network scheduler may also identify a location subsequent to the first node to route the first packet to, based at least on the first routing history of the first node being in consensus with the second routing history of the second node. The consensus based network algorithm can be partially or wholly implemented via Symmetric Asset Exchange (SAX) protocols as described above.

Routing histories are implemented as described above with respect to the section above “Label Switching Histories.” Specifically, the first routing history and the second routing history are implemented as directed trees that are well-decorated and well-labeled where the levels of the directed trees are ordered temporally. For Cellular HRCBV, the first routing history and the second routing history stores MPLS data about the first packet and the second packet respectively.

As we are discussing a Cellular HRCBV, we may implement service level agreements (SLAs) as a smart contracts as described above in the section titled “C2aaS”. Specifically, the Cellular HRCBV receives at the network scheduler a SLA for the first packet in the form of aa smart contract, wherein the identifying a location to route the first packet to is based at least on the received SLA. The smart contract comprising the SLA may be a composite smart contract. In other words, the smart contract is comprised of child smart contracts.

The SLA generally is comprised of a volume of data to route, a minimum level of Quality of Service (QoS), and a time window to route the volume of data. The SLA may also be comprised of one or more fields of data tracked in a call detail record (CDR).

As previously stated, the Cellular HRCBV contains a network abstraction comprised of different location types. In the case of an MPLS abstraction, the received network abstraction identifies virtual nodes at the atomic level. Beyond the atomic level, the received network abstraction level identifies groups of virtual nodes at the atomic level within a BGP AS domain and identifies BGP AS domains themselves. With these different levels of location types, identification of the location to route the first node vi9a a selection of a location type by an operad at the network scheduler.

There are many applications of a Cellular HRCBV. The identifying a location to route the first node to can be within the context of spectrum sharing allocation, auditing, and/or roaming. In the case of auditing, we mean reviewing the historical routing of packets to determine whether an SLA was satisfied (i.e the volume of data was transmitted correctly, with the specified QoS or better, and within the time constraints set forth by the time window.)

The received first routing history and the received second routing history is persisted in a central data store. The central data store may be a distributed ledger, or software transactional memory storing the transaction log of a relational database.

The identifying a location to route the first node to includes identifying a set of reachable locations by the first node. The identifying is performed by the network scheduler which may verify the set of reachable locations via an automated proof checker software. As described above, the automated proof checker software may make use of type theory, process calculi such as Pi-calculus, or both.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media storing computer-executable instructions that upon execution cause one or more computers to collectively perform acts comprising:
receiving at a network scheduler, a network abstraction of a physical network comprised of nodes and connections between the nodes;
receiving at the network scheduler a first routing history for a first packet located at a first node and a second routing history for a second packet located at a second node; and
identifying by the network scheduler via a consensus based network routing algorithm, a location subsequent to the first node to route the first packet to, based at least on the first node and the second node being in consensus as to the location of the first node and the location of the second node.

2. The one or more computer-readable storage media of claim 1, wherein the identifying a location to route the first packet to is based at least on the first node and the second node being in consensus as to the first routing history of the first node and the second routing history of the second node.

3. The one or more computer-readable storage media of claim 1, wherein the first routing history and the second routing history have implementations comprising directed trees that are well-decorated and well-marked where the levels of the directed trees are ordered temporally.

4. The one or more computer-readable storage media of claim 1, wherein the first routing history and the second routing history store multiprotocol label switching (MPLS) data about the first packet and the second packet respectively.

5. The one or more computer-readable storage media of claim 1, comprising: receiving at the network scheduler a service level agreement for the first packet in the form of a smart contract, wherein the identifying a location to route the first packet to is based at least on the received service level agreement.

6. The one or more computer-readable storage media of claim 1, wherein the smart contract is comprised of child smart contracts.

7. The one or more computer-readable storage media of claim 5, wherein the received service level agreement is comprised of a volume of data to route, a minimum level of Quality of Service (QoS), and a time window to route the volume of data.

8. The one or more computer-readable storage media of claim 7, wherein the physical network is a cellular network, and the received service level agreement is comprised of at least one field of data tracked in a call detail record (CDR).

9. The one or more computer-readable storage media of claim 7, wherein the received network abstraction identifies virtual nodes at the atomic level.

10. The one or more computer-readable storage media of claim 8, wherein the received network abstraction identifies groups of virtual nodes at the atomic level within a Border Gateway Protocol (BGP) Autonomous System (AS) domain, and identifies individual BGP AS domains.

11. The one or more computer-readable storage media of claim 1, wherein the location identified to route the first node to is via a selection of a location type by an operad at the network scheduler, wherein the location type is at least some of an atomic virtual node, a group of virtual nodes within a BGP AS domain, and a BGP AS domain.

12. The one or more computer-readable storage media of claim 8, wherein the identifying a location to route the first node to is within the context of any one of the following:
spectrum sharing allocation;
auditing; and
roaming.

13. The one or more computer-readable storage media of claim 5, wherein the received first routing history and the received second routing history is persisted in a central data store.

14. The one or more computer-readable storage media of claim 13, wherein the central data store is a distributed ledger.

15. The one or more computer-readable storage media of claim 13, wherein the central data store stores a transaction log of a relational database.

16. The one or more computer-readable storage media of claim 15, wherein the central data store stores a transaction log of a relational database is software transactional memory (STM).

17. The one or more computer-readable storage media of claim 1, wherein the identifying a location to route the first node to includes identifying a set of reachable locations by the first node.

18. The one or more computer-readable storage media of claim 17, comprising verifying via the set of reachable locations is determined via by applications of type theory, process calculus, or both.

19. The one or more computer-readable storage media of claim 17, comprising verifying via the set of reachable locations via an automated proof checker software.

20. The one or more computer-readable storage media of claim 1, wherein the consensus based network routing algorithm is at least partially implemented via Symmetric Asset Exchange (SAX).
